(19) United States
(12) Patent Application Publication
(10) Pub. No.: US 2024/0016331 A1
(43) Pub. Date: Jan. 18, 2024

(54) BREWING UNIT OF A PISTON COFFEE MACHINE, PISTON COFFEE MACHINE COMPRISING A BREWING UNIT AND METHOD FOR FILLING A BREWING UNIT

(71) Applicant: Melitta Professional Coffee Solutions GmbH & Co. KG, Minden (DE)

(72) Inventors: Armin HENSEL, Rahden (DE); Kai HALLMANN, Minden (DE); Bernd BUCHHOLZ, Rahden (DE)

(73) Assignee: Melitta Professional Coffee Solutions GmbH & Co. KG, Minden (DE)

(21) Appl. No.: 18/036,671

(22) PCT Filed: Nov. 17, 2021
(86) PCT No.: PCT/EP2021/081978

§ 371 Date: May 12, 2023

(30) Foreign Application Priority Data
Nov. 19, 2020 (DE) 10 2020 130 632.6

(51) Int. Cl. A47J 31/36; A47J 31/42

(52) U.S. Cl. CPC A47J 31/3614; A47J 31/42

(57) ABSTRACT

A brewing unit is formed with a brewing slide as a brewing chamber, a filling tray, a machine frame with two base plates, two piston units as a shower screen and a plunger, and at least one drive motor, wherein the brewing unit is adjustable into four brewing unit positions, wherein the second brewing unit position forms a first filling position of the brewing unit for the supply of coffee powder or cleaning agents, and wherein the second brewing unit position forms a first filling position of the brewing unit for the supply of coffee powder or cleaning agents. The brewing unit has at least one second filling position for the supply of coffee powder or cleaning agents in the brewing unit position. A coffee piston machine and a process for filling a brewing unit are created.

The invention relates to a brewing unit of a piston coffee machine according to the generic concept of claim 1. The invention also relates to a piston coffee machine with such a brewing unit and to a process for filling such a brewing unit.

Brewing units of piston coffee machines are known in many designs. Inside the brewing unit of a piston coffee machine, coffee powder is ground into a brewing chamber and then pressed into a coffee cake. Water heated under overpressure is then passed through the cake to extract flavours from the powder. After a product-specific amount of water has flowed through, the moistened coffee powder is pressed out and the coffee cake (pomace) is discharged into the pomace container.

A typical brewing unit brewing chamber is circular and has a diameter of, for example, about 45 mm. The hot water is introduced into the brewing chamber on one side by a piston unit called a shower screen, atomising it as evenly as possible to wet all parts of the coffee cake with water. On the other side, the extracted coffee is dispensed through a plunger that forms another piston unit. In this process, the extracted coffee is often passed through a spring-loaded oscillating component (crema valve) that allows only a small opening gap to produce the typical crema on the coffee.

To prevent very fine particles from being discharged into a coffee cup, there is often a fine sieve on the plunger.

A drive motor causes a relative movement between the plunger and the shower screen so that the distance between them can be changed. Defined pressing forces can then be set via different motor torques.

At the same time, the brewing chamber must also be moved in order to realise the insertion position for the coffee powder, to create a sealed brewing chamber space and finally to be able to eject the pressed coffee cake. In horizontal brewing units, the ejection is often done by gravity. In vertical units, there is usually an additional movement mechanism to eject the cake via a pusher into the pulp container. The coffee cake height can be used to indirectly deduce the weight and this can then be specifically adjusted to a nominal weight, for example to correct variable grinding capacities of the grinder. The plunger or shower screen position during powder pressing is easily detected via the motor increments.

Basically, a distinction is made between two installation types of brewing units. Horizontal (lying) and vertical (standing) units. The horizontal variant has the advantage that the coffee machine can be formed very compactly and that the coffee grounds are often only discharged into the grounds container by gravity.

Upright brewing units usually require an additional pusher mechanism for coffee ground ejection. However, they also have the option of processing larger weights and the coffee powder can be compacted more evenly.

There are different drive concepts for approaching the necessary relative positions of the plunger, shower screen and brewing chamber.

First, the two asynchronous motion sequences can be implemented via two different drive motors. One motor is then responsible for moving the brewing chamber and another for pressing the coffee powder. The disadvantage of this simple solution is that two drives are often very cost-intensive. Additional motors are often also used for a pusher movement to eject the coffee grounds into a grounds drawer. Here, movement threads such as trapezoidal spindles by means of sliding blocks enable the rotary movement of the drive to be converted into a linear piston movement in many designs.

If only one motor is available, the relative positions are generated, for example, via control grooves (e.g. in a control roller). In this case, several components (plunger slide, brewing bush) are simultaneously guided in grooves via a rotary movement. The disadvantages here are complex and non-compact designs, as well as high bending moments due to off-centre guides.

The toggle lever principle is often found in the household sector. A complex kinematic approach is used to generate a functional linear movement via several joints. The disadvantage is usually that the piston elements can be moved quickly, but the coffee powder is compacted with the same force regardless of the product. Defined and variable forces with larger dimensions cannot be represented.

Generally, in favourable designs of brewing units, a compromise is accepted between fast movement of the piston function elements and a defined, adjustable pressing of the coffee powder.

The coffee powder is fed in either via the grinders or via a chute for external addition of the powder. The brewing unit is in a defined position (filling position) in which the ground coffee can fall into the brewing chamber between the plunger and the shower screen. The maximum weight of horizontal brewing groups is limited to a large extent by the piston diameter. With a typical diameter of 45 mm, the maximum weight of a coherent grind is around 15-17 g.

So-called filling trays are known from the state of the art for increasing the weight, in which the coffee powder is collected and then moved into the actual brewing chamber via a stroke movement of the plunger or the shower screen. Subsequently, a further grind can be added to the released tray. Accordingly, the brewing cylinder is filled in several partial steps, with pre-compaction being carried out after the filling of individual partial quantities and final compaction of the coffee powder being carried out after the filling of the last partial quantity.

Document DE 20 2009 000 075 U1 describes a brewing unit for a coffee machine, comprising a brewing cylinder which is driven movably in the direction of the longitudinal axis of the brewing unit by a spindle drive, which spindle drive has a threaded spindle arranged parallel to and at a distance from the longitudinal axis of the brewing cylinder, the thread of which threaded spindle meshes with an output element associated with the brewing cylinder for moving the same, and a guide rod arranged parallel to and at a distance from the threaded spindle with a guide sleeve associated with the brewing cylinder and displaceable thereon. In addition to its guide sleeve, the brewing cylinder carries on its outer circumferential surface at least one guide element that is supported on the guide rod only in sections relative to its circumference.

These designs have proven themselves, but in the course of cost savings in components, functional groups, assembly times and maintenance, there is a constant need for improvements.

The object of the present invention is therefore advantageously further developing a brewing unit of a piston coffee machine in order to create an improved brewing unit and an improved piston coffee machine.

Another object is to provide a process for filling a brewing unit of a piston coffee machine.

The invention solves this problem by means of a brewing unit having the feature of claim 1, having the feature of claim 7, by means of a piston coffee machine having the feature of claim 13 and by means of a process having the feature of claim 14.

One idea of the invention is that the brewing unit comprises at least a second filling position.

A first embodiment of a brewing unit according to the invention, particularly of a horizontally aligned brewing unit, of a piston coffee machine, wherein the brewing unit is formed with a brewing slide as brewing chamber, a filling tray, a machine frame with two base plates, two piston units as a shower screen and a plunger, and at least one drive motor, wherein the brewing unit is adjustable in four brewing unit positions, wherein the second brewing unit position forms a first filling position of the brewing unit for the supply of coffee powder or cleaning agents, wherein the brewing unit comprises at least one second filling position for the supply of coffee powder or cleaning agents in the first, third and/or fourth brewing unit position, wherein the brewing slide and the filling tray form separate assemblies and can be coupled to one another via at least one holding element, wherein the brewing slide is the driven component and the filling tray is the component indirectly pushed or pulled by the drive via the brewing slide, the filling tray comprising an outwardly pointing filling neck which is connected to an interior of the filling tray via an opening. The filling tray is pushed onto a storage sleeve in the at least one second filling position of the brewing unit in the first brewing unit position and in the third filling tray position in the third and fourth brewing unit positions, which storage sleeve is then arranged in the interior of the filling tray and closes the opening of the filling neck of the filling tray.

A particular advantage of this is not only a very compact and lightweight design, which enables a simple and thus cost-effective construction, but also that the at least one second filling position can be used both for the external addition of coffee powder (C-free insertion) and for the addition of cleaning agents, e.g. cleaning tablets.

If the brewing slide and the filling tray form separate assemblies and can be coupled to one another via at least one holding element, wherein the brewing slide is the driven component and the filling tray is the component pushed or pulled indirectly by the drive via the brewing slide, it is advantageously possible to enable simple decoupling and coupling to implement different brewing unit positions.

The filling tray comprises an outward-facing filling neck which is connected to an interior of the filling tray via an opening. The shape of the filling neck can be different, e.g. a hollow cylinder with a circular or oval or angular cross-section. The filling neck can extend radially or also obliquely outwards from the filling tray. This allows for an advantageously compact component. It is also possible that the filling neck can even advantageously replace the conventional funnel between the grinder and the brewing unit if the height is appropriate.

It is particularly preferred that the filling tray is pushed onto a storage sleeve in the at least one second filling position of the brewing unit in the first filling tray position in the first brewing unit position and in the third filling tray position in the third and fourth brewing unit positions, which is then arranged in the interior of the filling tray and closes the opening of the filling neck of the filling tray. This is particularly advantageous as it provides a simple closure of the filling neck opening and the filling neck can be used as a storage for coffee powder and cleaning agent.

A second embodiment as an alternative of a brewing unit according to the invention, in particular horizontally aligned brewing unit, of a piston coffee machine, wherein the brewing unit is formed with a brewing slide as brewing chamber, a filling tray, a machine frame with two base plates, two piston units as shower screen and plunger, and at least one drive motor, wherein the brewing unit is adjustable into four brewing unit positions, wherein the second brewing unit position forms a first filling position of the brewing unit for the supply of coffee powder or cleaning agents, wherein the brewing unit comprises at least one second filling position for the supply of coffee powder or cleaning agents in the first, third and/or fourth brewing unit position, is characterised in that the brewing slide is fixedly connected to the filling tray and/or is formed in one piece (one-piece).

One advantage of this is that the filling tray does not have to be carried along indirectly by the brewing slide and the holding elements required for this can be omitted.

A piston coffee machine according to the invention comprises the brewing unit described above.

A process according to the invention for filling the brewing unit of a coffee piston machine described above is formed in such a way that the brewing unit is filled in a first filling position of the brewing unit or/and in at least one second filling position of the brewing unit.

One advantage here is that the overall arrangement can be implemented very compactly in coffee machines with more than two grinders.

Further advantageous embodiments can be found in the other subclaims.

It is advantageous if the at least one holding element is a permanent magnet, electromagnet or/and a controllable mechanical coupling, as this allows a quick coupling and decoupling to be realised.

A further embodiment provides that the filling tray can be fixed in the at least one second filling position of the brewing unit in a first filling tray position in the first brewing unit position and in a third filling tray position in the third and fourth brewing unit position by means of at least one electromagnet or a controllable hydraulic seal. By means of the controllability, an advantageously simple fixation is possible.

For an advantageously compact design, it is provided that the storage sleeve is a hollow cylinder with a circular cross-section and is arranged between a plunger head of the plunger and a plunger base plate.

Furthermore, it is provided that in the first filling position of the brewing unit, the filling tray is in the third brewing unit position in a second filling tray position in which the opening of the filling spout of the filling tray is open and connected to the interior of the filling tray. This enables a first filling position for direct filling of the filling tray in a simple way.

It is also provided that in the first brewing unit position, a distance is formed between the brewing slide and the filling tray, which defines an ejection area. In this way, it is advantageously possible to provide direct access to a collecting vessel under the ejection area by separating the brewing slide and the filling tray. Another advantage is that water vapour wetting of the funnel that transports the coffee powder from the grinders to the brewing unit can be avoided.

An advantageously compact design can be achieved in the alternative embodiment in that the brewing slide is formed in one piece with the filling tray in such a way that the brewing slide is arranged in an interior space of the filling tray.

For this purpose, it is advantageous in the alternative embodiment if the brewing slide is formed in one piece/integrally with the filling tray in such a way that the brewing slide is arranged in an interior space of the filling tray. For example, such a one-piece filling tray and brewing slide combination can consist of an injection moulded housing and a metal inlay. The metal inlay forms the brewing slide with the brewing chamber within the surrounding injection moulded housing.

Furthermore, in the alternative embodiment, it is provided that the filling tray comprises an outwardly facing filling neck that is connected to an interior of the brewing slide via an opening and a further opening of the brewing slide. In this way, the filling neck can be in communication with the interior of the brewing slide, i.e. the brewing chamber. Of course, the filling neck in this design can also advantageously replace the conventional funnel between the grinder and the brewing unit if the height is appropriate.

In a still further design of the alternative embodiment, the shower screen is connected to a storage sleeve, wherein the storage sleeve with the connected shower screen is inserted into the interior of the brewing slide, which is formed integrally with the filling tray, in the at least one second filling position of the brewing unit in the first brewing unit position and in the third and fourth brewing unit positions, which then closes the opening of the brewing slide and the opening of the filling neck of the filling tray. One advantage of this is that the storage sleeve can be moved together with the adjustable shower screen in this way and does not require an additional drive.

It is advantageous if, in the first brewing unit position, a distance is formed between the brewing slide, which is firmly connected to the filling tray, and the plunger, which defines an ejection area.

In an advantageous embodiment, the brewing unit is formed as a spindle brewing unit. This results in a simple and compact design.

In a particularly preferred embodiment of the process, filling the brewing unit in the first filling position comprises the following process steps. (VS1) Moving the brewing unit into a second brewing unit position, which forms the first filling position; (VS2) Grinding and/or filling coffee powder through a filling neck of a filling tray into an interior of the filling tray or into an interior of a brewing slide, if the brewing slide and the filling tray are formed in one piece and the brewing slide is arranged inside the filling tray; (VS3) Filling further coffee powder through the filling spout of the filling tray into the interior of the filling tray or into the interior of the brewing slide, if the brewing slide and the filling tray are formed in one piece and the brewing slide is arranged inside the filling tray, wherein a filling height limit of the interior of the filling tray or of the interior of the brewing slide is exceeded, the interior of the filling tray or the interior of the brewing slide thereby fills completely with coffee powder and the further excess coffee powder accumulates in the filling neck of the filling tray; and (VS4) At least one reciprocating movement of the brewing slide, a shower screen and the filling tray or a shower screen connected to a storage sleeve, if the brewing slide and the filling tray are formed in one piece and the brewing slide is arranged inside the filling tray, and drawing the coffee powder stored in the filling sleeve of the filling tray into the interior of the brewing slide and compressing the stored coffee powder with the coffee powder present in the interior of the brewing slide, wherein the brewing unit performs the at least one back and forth movement from the second brewing unit position via the third brewing unit position into the fourth brewing unit position or from the second brewing unit position into the third brewing unit position, if the brewing slide and the filling tray are formed in one piece and the brewing slide is arranged within the filling tray, and back again at least once. A great advantage here is that a large addition of coffee powder can be achieved with only one grinder control.

In one variant of the process, the filling of the brewing unit in the at least one second filling position comprises the following process steps: (VS′1) Moving the brewing unit into a first, third or fourth brewing unit position, which in each case forms a second filling position; (VS′2) Grinding or filling coffee powder into a filling neck of a filling tray and storing the coffee powder in the filling neck of the filling tray and moving the brewing unit into the second brewing unit position, wherein the coffee powder stored in the filling neck of the filling tray passes into an interior of the filling tray or into an interior of the brewing slide if the brewing slide and the filling tray are formed in one piece and the brewing slide is arranged inside the filling tray; (VS′3) Remaining of excess coffee powder in the filling neck of the filling tray when filling the interior of the filling tray or the interior of the brewing slide when the brewing slide and the filling tray are of one-piece design and the brewing slide is arranged inside the filling tray, a filling height limit of the interior of the filling tray or of the interior of the brewing slide, if the brewing slide and the filling tray are formed in one piece and the brewing slide is arranged inside the filling tray, is exceeded with the coffee powder stored in the filling spout of the filling tray; and (VS′4) at least one of reciprocating a brewing slide, a shower screen and the filling tray or a shower screen connected to a storage sleeve when the brewing slide and the filling tray are integrally formed and the brewing slide is disposed within the filling tray, and drawing the coffee powder stored in the filling sleeve of the filling tray into the interior of the brewing slide and further compressing the stored coffee powder with the coffee powder present in the interior of the brewing slide, wherein the brewing unit performs the at least one back and forth movement from the second brewing unit position via the third brewing unit position into the fourth brewing unit position or from the second brewing unit position into the third brewing unit position, if the brewing slide and the filling tray are formed in one piece and the brewing slide is arranged inside the filling tray, and back again at least once.

This results in the advantage of adding larger quantities of coffee powder to the standard filling position in one continuous grinding process. In this case, the coffee is deliberately ground above the actual possible filling level and the excess coffee powder is pushed over the storage sleeve. This powder is then drawn into the brewing chamber by additional back and forth movements of the shower screen or the brewing slide. This movement leads to an optimised distribution of the total amount of powder in the existing brewing chamber. Overall, filling the brewing group with larger weights can be done much faster than if the powder is ground in several partial steps.

In one embodiment, a permanent grinding process takes place in the process steps (VS2, VS3) of grinding and filling coffee powder, whereby the brewing slide and the filling tray are moved back and forth/reciprocatingly quickly and the coffee powder is distributed in the interior of the filling tray or in the interior of the brewing slide during the grinding process.

This is advantageous because more than the usual 13 to 15 g of coffee powder can be ground in one continuous grinding process. This rapid back and forth/reciprocating movement of the brewing slide with filling tray is also called “shaking”. A stroke of this rapid back and forth movement is only so great that the side of the respective interior of the filling tray or the brewing slide facing the plunger base plate remains closed by the plunger. This means that the stroke of the back and forth movement comprises a maximum length that is smaller than the length of the plunger in the direction of the inner spindle axis.

The term “permanent grinding process” means that the grinding process is only interrupted during the filling of coffee powder into the respective interior when a predetermined amount of coffee powder is present in the respective interior. This can be done, for example, by detecting the position of the shower screen, e.g. by detecting the angle of the positioning drive.

In a further embodiment of the process, it is provided that before the first process step (VS1, VS′1) or/and after a brewing operation after the fourth process step (VS4, VS′4), a cleaning operation is carried out by filling cleaning agents, in particular cleaning tablets, into the filling neck of the filling tray in the at least one second filling position of the brewing unit in the first or fourth brewing unit position, wherein thereafter the cleaning agents or cleaning tablets are held in the filling neck by closing the opening of the filling neck by the storage sleeve until the cleaning agents or cleaning tablets are drawn into the brewing space in the interior of the brewing slide in the second brewing unit position at a time defined by machine software of a control of the brewing unit and are then dissolved by hot water. This is particularly advantageous as no additional cleaning assemblies are required.

A still further embodiment of the process provides that before the first process step (VS1, VS′1) or/and after a brewing operation after the fourth process step (VS4, VS′4), in the first brewing unit position, a spacing is formed between the brewing slide and the filling tray or between the brewing slide connected to the filling tray and a plunger, if the brewing slide and the filling tray are formed in one piece and the brewing slide is arranged inside the filling tray, which spacing defines an ejection area.

Here it is possible that coffee powder is ground through the brewing unit into a collecting container in the ejection area, whereby the ground coffee powder can be assessed with regard to the degree of fineness and grinding quantity. This makes it advantageously simple and quick to carry out such an assessment.

The advantages over conventional brewing unit designs for coffee machines are highlighted below:
The second filling position can be used both for the external addition of coffee powder (C-free insert) and for the addition of cleaning tablets.
Overall arrangement in coffee machines with more than two grinders can be realised very compactly
Large addition of coffee powder possible with only one grinder control
Avoiding water vapour wetting of the funnel that transports the coffee powder from the grinders to the brewing unit.
Very compact and lightweight design
Simple and thus cost-effective/cheap assembly
Only one drive motor necessary
Grinding position in the pomace container

In the following, the invention is described in more detail by means of two embodiment examples with reference to the drawings. The figures serve only to explain the invention in more detail and are not restrictive of the invention. Individual features described may also be applied in their own right to further embodiments within the scope of the general skill in the art. It shows:

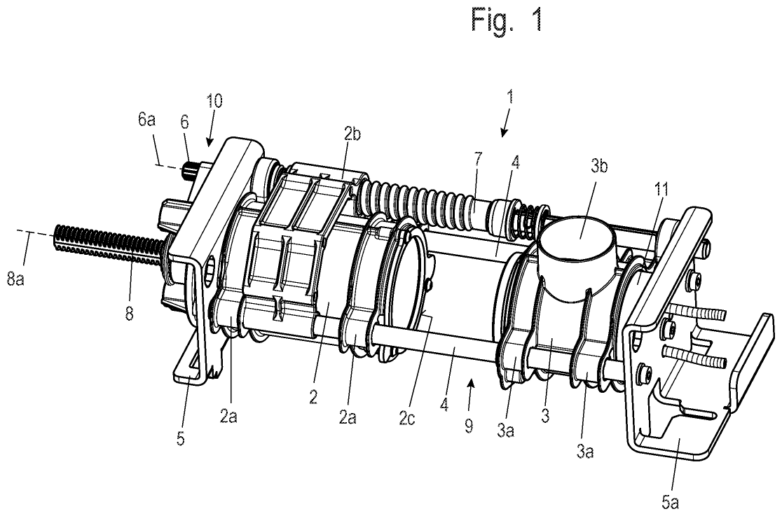

FIG. 1: a schematic perspective view of a first embodiment of a brewing unit of a piston coffee machine according to the invention in an open position;

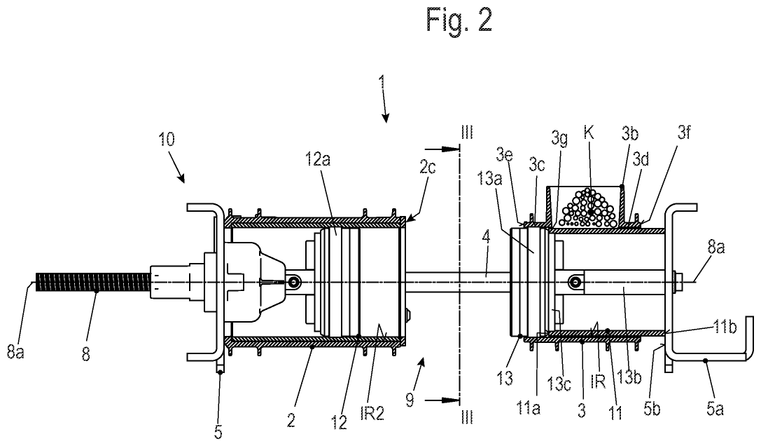

FIG. 2: a schematic longitudinal section of the first embodiment according to FIG. 1;

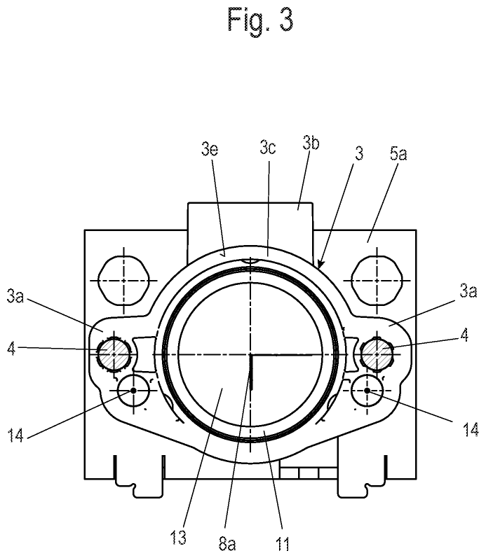

FIG. 3: a schematic view according to line Ill-Ill of FIG. 2;

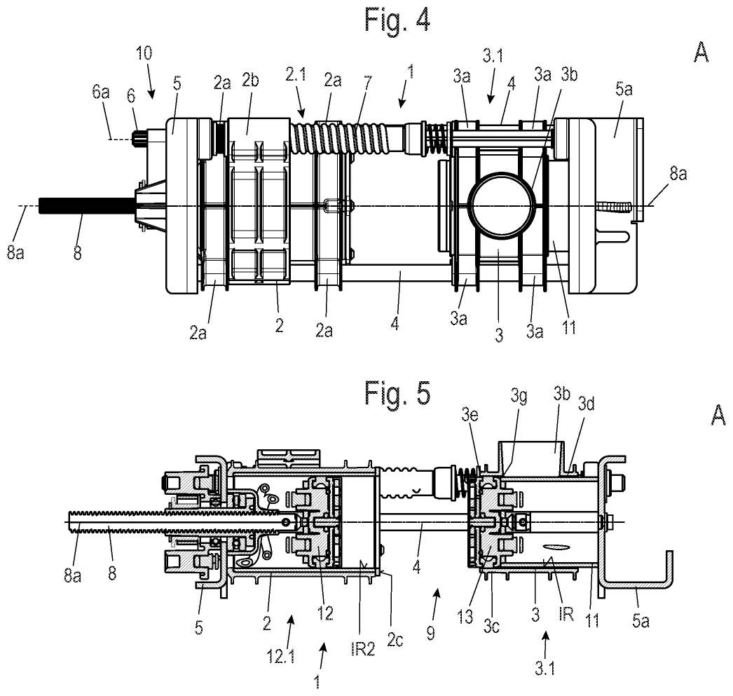

FIG. 4-5: schematic views of the first embodiment according to FIG. 1 in the open position;

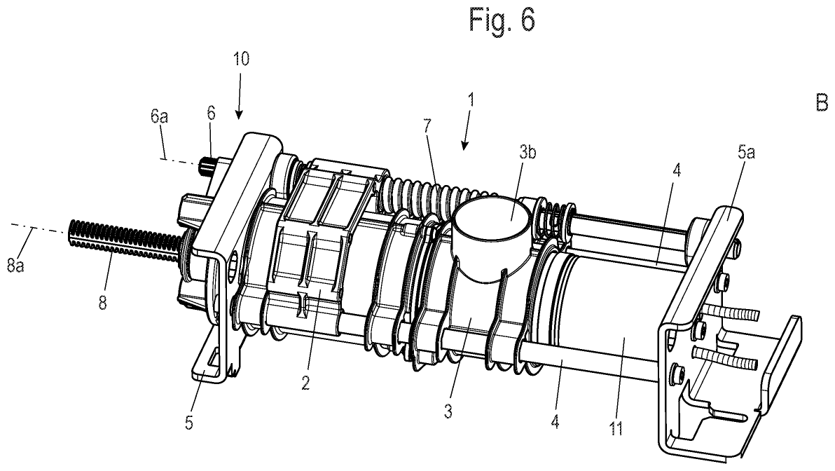

FIGS. 6-8: schematic views of the first embodiment according to FIG. 1 in a first filling position;

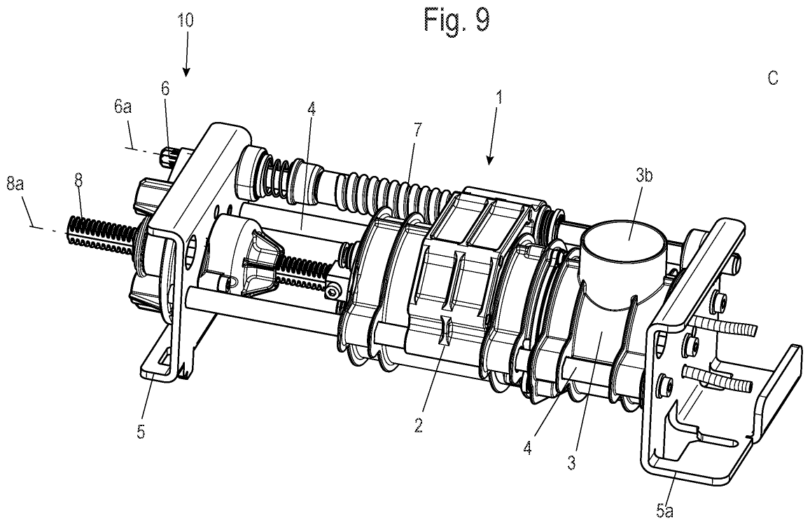

FIGS. 9-11: schematic views of the first embodiment according to FIG. 1 in an immersion position;

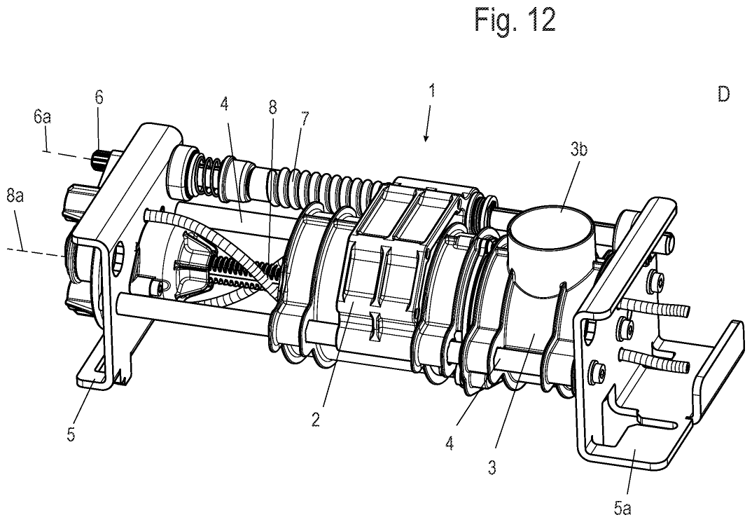

FIGS. 12-14 schematic views of the first embodiment according to FIG. 1 in a closed position;

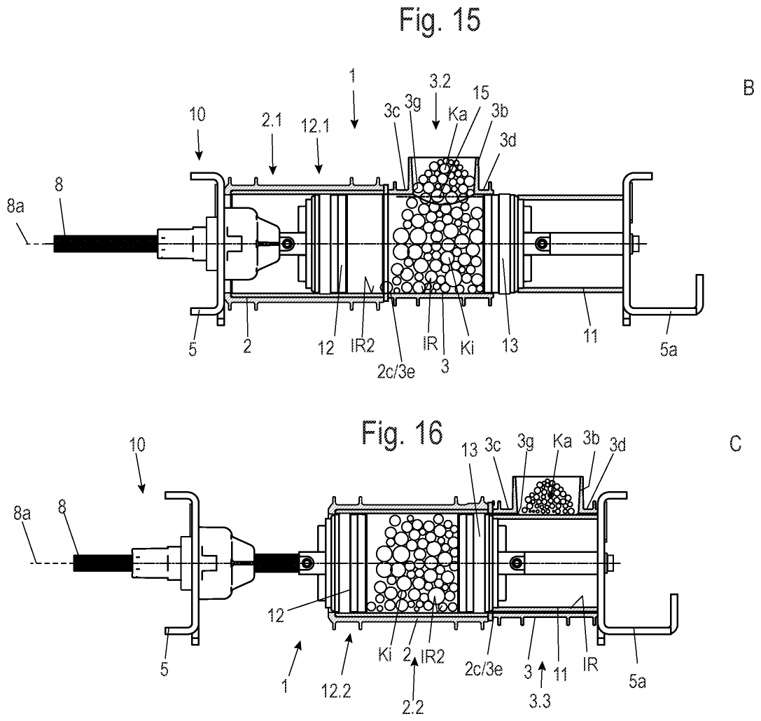

FIGS. 15-16 schematic sectional views of the first embodiment according to FIG. 1 in various positions;

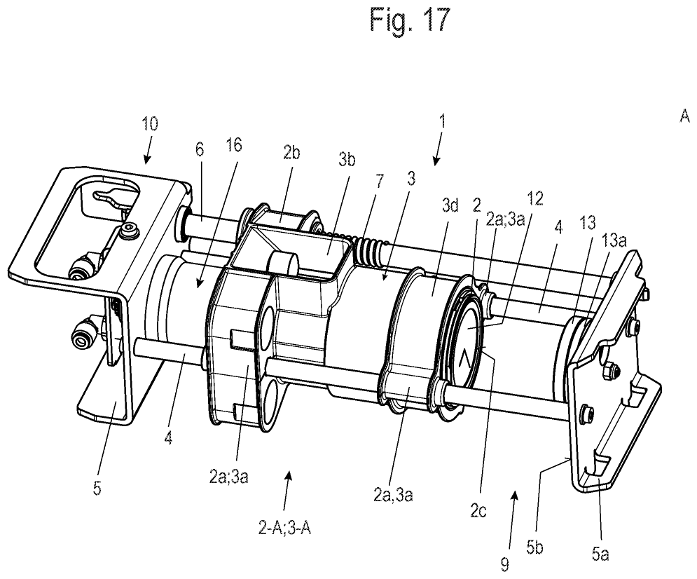

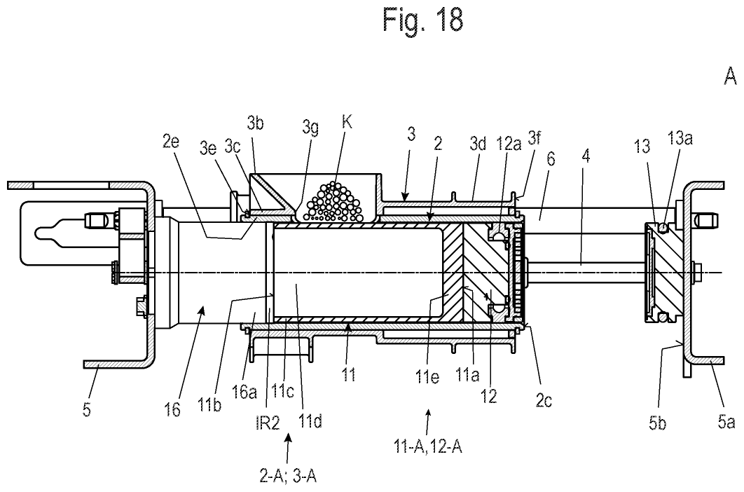

FIGS. 17-18 schematic views of a second embodiment in an open position;

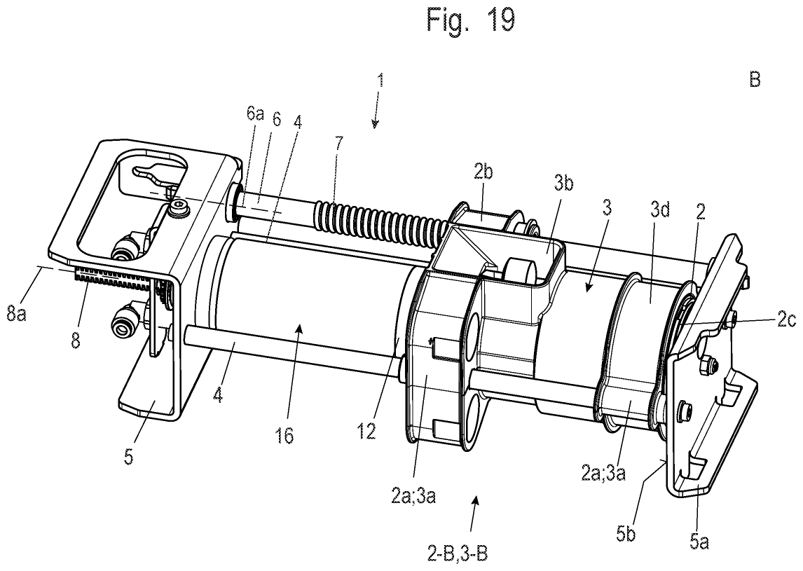

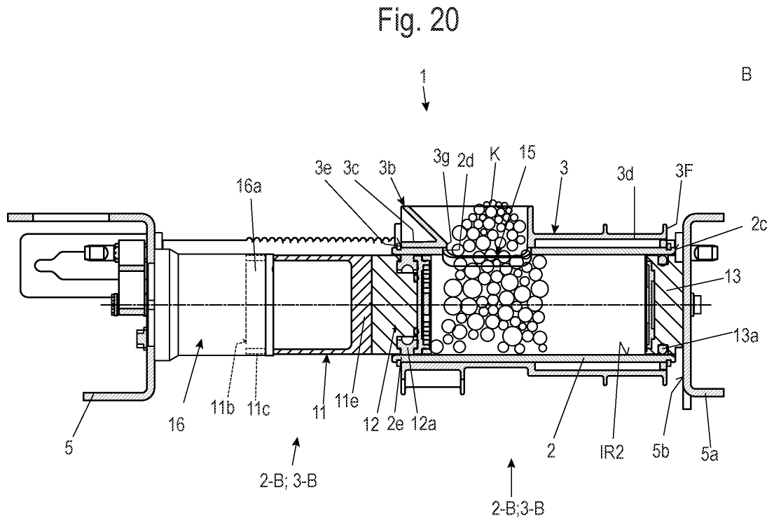

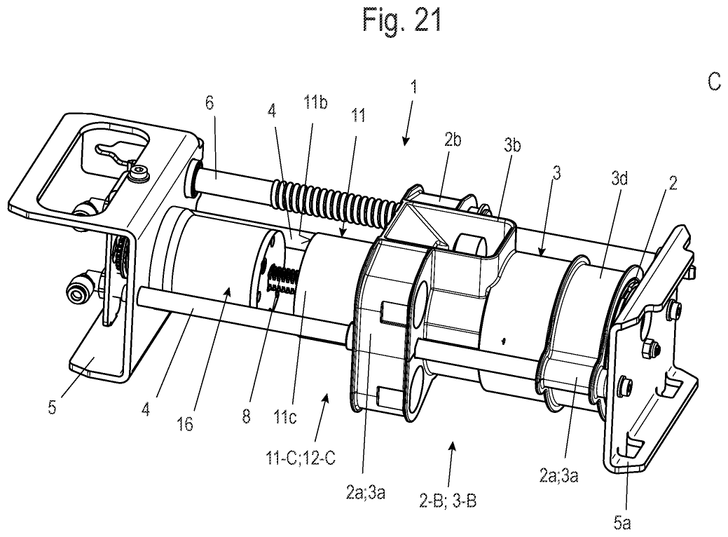

FIG. 19-20 schematic views of the second embodiment according to FIG. 17-18 in a first filling position;

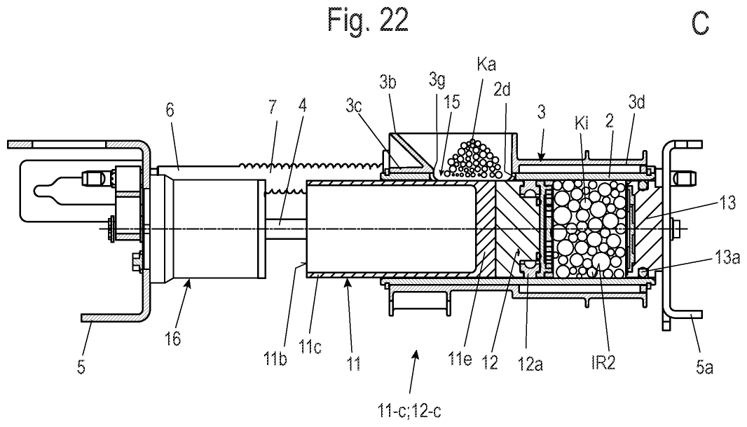

FIGS. 21-22 schematic views of the second embodiment according to FIG. 17-18 in an immersion position;

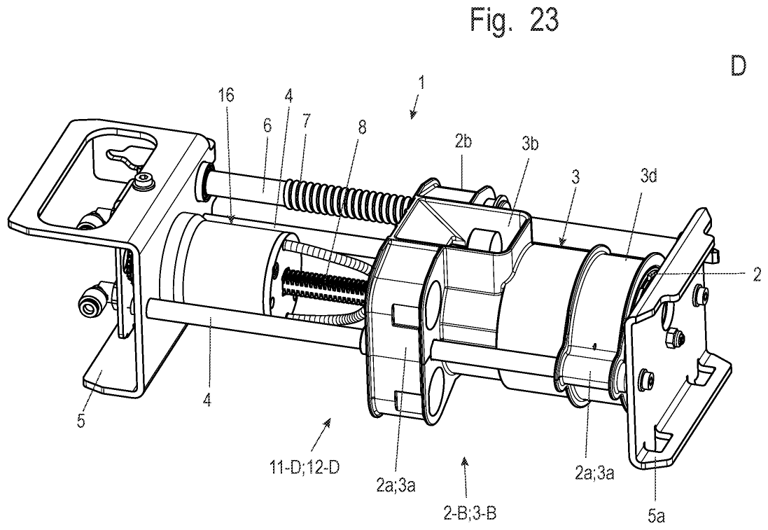

FIG. 23 a schematic view of the second embodiment according to FIGS. 17-18 in a closed position; and

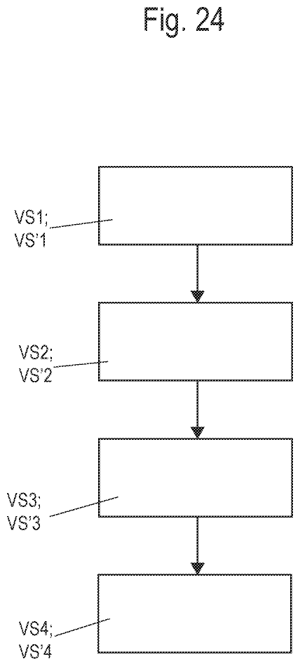

FIG. 24 a schematic flow chart of an embodiment of a process according to the invention.

FIG. 1 shows a schematic perspective view of a first embodiment of a brewing unit 1 of a piston coffee machine according to the invention. FIG. 2 shows a schematic longitudinal section of the first embodiment according to FIG. 1. FIG. 3 shows a schematic view according to line Ill-Ill from FIG. 2.

The brewing unit 1 is shown here in a horizontal design. The design can also be transferred to a vertical brewing unit 1 or one with any other angle of inclination. The brewing unit 1 is a spindle brewing unit.

The brewing unit 1 comprises here a brewing slide 2 with an interior IR2, also referred to as a brewing chamber, a filling tray 3, two tie rods 4, a machine frame with two base plates 5 and 5a, an outer spindle 6 with a movement thread 7, an inner spindle 8, a storage sleeve 11 and two piston units, namely a so-called shower screen 12 and a plunger 13.

The tie rods 4 run parallel and connect the base plates 5 and 5a to each other. The base plate 5 is called the drive base plate 5 because a drive motor of the brewing unit 1 is attached to it. This side of the brewing unit 1 is also referred to as the drive side 10. The other base plate 5a is called the plunger base plate 5a here and carries the plunger 13 with the storage sleeve 11.

The inner spindle 8 with an inner spindle axis 8a and the tie rods 4 lie parallel to each other in a common, here horizontal plane, whereby the inner spindle 8 is arranged in the middle between the tie rods 4. The inner spindle axis 8a is also a central centre line of the brewing unit 1 with an imaginary extension.

The brewing slide 2, the filling tray 3, the storage sleeve 11, the shower screen 12 and the plunger 13 are arranged in the brewing unit 1 coaxially with respect to each other and coaxially with respect to the inner spindle axis 8a.

The brewing slide 2 comprises a hollow cylindrical body in whose interior IR2 the brewing chamber is formed. The filling tray 3 is also formed as a hollow cylindrical body with an interior IR.

The brewing slide 2 and the filling tray 3 are mounted on the tie rods 4 so that they can be moved in the direction of the inner spindle axis 8a. For this purpose, the brewing slide 2 and the filling tray 3 each comprise two guide sections 2a, 3a on each side, through each of which one of the tie rods 4 extends.

The brewing slide 2 is provided on one side with a drive section 2b through which the outer spindle 6 with the movement thread 7 extends. By rotating the outer spindle 6 and thus the movement thread 7, its rotational movement is converted into a longitudinal movement of the brewing slide 2 by means of the drive section 2b, which comprises a movement nut corresponding to the movement thread. The direction of rotation of the outer spindle 6 determines the direction of adjustment of the brewing slide 2, either in the direction of the plunger base plate 5a or in the opposite direction towards the drive base plate 5.

The shower screen 12 is arranged in the brewing slide 2 so as to be displaceable in the direction of the inner spindle axis 8a relative to the brewing slide 2 and is driven by the inner spindle 8 so as to be adjustable back and forth.

The plunger 13 is firmly attached to the plunger base plate 5a by means of a tubular plunger holder 13b, the storage sleeve 11 being fixed between a plunger head 13c of the plunger 13 and a plunger side 5b of the plunger base plate 5a concentrically to the inner spindle axis 8a. In this case, an interior IR of the storage sleeve 11 is closed off from the plunger head 13c by an end face 11a of the storage sleeve 11 that lies tightly against the latter and by an end face 11b of the storage sleeve 11 that lies tightly against the plunger side 5b of the plunger base plate 5a.

The filling tray 3 is pushed slidably over the storage sleeve 11 and the plunger head 13c in the direction of the inner spindle axis 8a.

The filling tray 3 compries a filling neck 3b, which is attached here to the top of the filling tray 3 and points outwards, here in particular radially. The filling neck 3b is here a hollow cylinder with a circular cross-section, the interior of which is connected to an interior IR of the filling tray 3 via an opening 3g in the circumferential wall of the filling tray 3. In the position of the filling tray 3 shown in FIG. 2, the opening 3g is closed by the outer wall of the storage sleeve 11. In this way, coffee powder K in the filling neck 3b remains stored in the filling neck 3b in this position of the filling tray 3.

With a corresponding height, i.e. radial expansion, of the filling neck 3b, the filling neck 3b can replace a conventional funnel for guiding the ground material between the grinder and the brewing unit 1.

A collar 3c, 3d with a respective end face 3e, 3f is formed on both sides of the filling neck 3b of the filling tray 3 in the axial direction. The end faces 3e, 3f serve as a stop in certain positions of the filling tray 3. This will be described in more detail below. An inner side of the collar 3c of the filling tray 3, which faces the drive base plate 5, serves here in cooperation with a circumferential controllable seal 13a, e.g. a hydraulic seal, of the plunger head 13c of the plunger 13 for controllable fixing of the filling tray 3 in certain positions. This will be explained in more detail below.

The brewing slide 2, the filling tray 3 and the shower screen 12 are independently and dependently adjustable into different positions to realise certain brewing unit positions A, B, C, D for a piston coffee machine not shown by means of the double spindle arrangement of outer spindle 6 and inner spindle 8 and a drive (not shown here, but easily imaginable).

The brewing unit positions A, B, C, D are designated as the first brewing unit position A, the second brewing unit position B, the third brewing unit position C and the fourth brewing unit position D.

Via only one drive motor (not shown) on the drive base plate 5, the outer spindle 6 and the inner spindle 8 are driven here, coupled by a gear not shown, in such a way that a relative movement between the stationary plunger 13 and the adjustable shower screen 13 takes place by changing the distance between them. Defined pressing forces can then be set via different motor torques. At the same time, a movement of the brewing slide 2 must also take place in order to realise an insertion position for the coffee powder K, to create a sealed brewing chamber space in the brewing slide 2 and finally to be able to eject the pressed-out coffee cake.

Of course, it is also possible that not only one drive motor, but several drive motors are provided. Thus, the outer spindle 6, the inner spindle 8 and/or the filling tray 11 can each be driven by a separate drive motor. A corresponding control system is required for this.

The coffee powder K is fed via the filling tray 3, which is guided on the same tie rods 4 as the brewing slide 2. The brewing slide 2 is moved at a significantly higher speed than the shower screen 12. In this way, the necessary relative positions of the functional components brewing slide 2, filling tray 3 and shower screen 12 in relation to the stationary plunger 13 are realised. The shower screen 12 is moved by the driven inner spindle 8.

The brewing slide 2 and the filling tray 3 form separate assemblies and can be coupled to each other via holding elements 14, e.g. permanent magnets (see FIG. 3). The brewing slide 2 is the driven component and the filling tray 3 is the component indirectly pushed or pulled by the drive via the brewing slide 2. The filling tray 3 can also be held in its end position. For example, an electromagnet or a hydraulic seal (e.g. the circumferential seal 13a) is suitable for this. The great advantage of this design principle is that only the brewing slide 2 has to be pulled over the marc for the coffee ground ejection. No separate drive of the filling tray 3 is necessary. This results in a particularly compact design of the brewing unit 1.

The different movement possibilities of the movable assemblies brewing slide 2, filling tray 3 and shower screen 12 result on the one hand in the respective positions of these assemblies and on the other hand in the brewing unit positions A, B, C, D of the brewing unit 1.

The brewing unit positions A, B, C, D are described in detail below.

In FIGS. 1, 2, 4, 5 the position of the brewing unit 1 is shown as a brewing unit position A as a so-called open position of the brewing unit 1. FIGS. 5 and 6 show the positions of the brewing slide 2, filling tray 3 and shower screen 12 in detail. FIG. 5 shows a top view of the brewing unit 1, while FIG. 6 shows a longitudinal section of the brewing unit 1.

In the brewing unit position A, the brewing slide 2 is in a brewing slide position 2.1, which is referred to as the starting position. In this position, the brewing slide 2 is in abutment on the drive base plate 5.

The shower screen 12 is also in a starting position, which is called shower screen position 12.1 here. The shower screen 12 is in an indirect abutment/stop on the drive base plate 5 inside the brewing slide 2.

The filling tray 3 is in its starting position as filling tray position 3.1 on the storage sleeve 11, whereby the collar 3c of the filling tray 3 facing the drive base plate 5 surrounds the seal 13a of the plunger 13. The controllable seal 13a fixes the filling tray 3 in this filling tray position 3.1. However, in the filling tray position 3.1, the filling tray 3 is not in abutment against the plunger base plate 5a with its other collar 3d facing the plunger base plate 5a.

In this brewing unit position A, a distance is formed between an end face 2c of the brewing slide 2 facing the plunger base plate 5a and the end face 3e of the filling tray 3 facing the drive base plate 5, which defines an ejection area 9. For example, a collecting vessel for the coffee cake pressed out after a brewing process can be provided below this ejection area 9.

A first filling position, also called conventional filling position or conventional filling position, is assumed in the brewing unit position B.

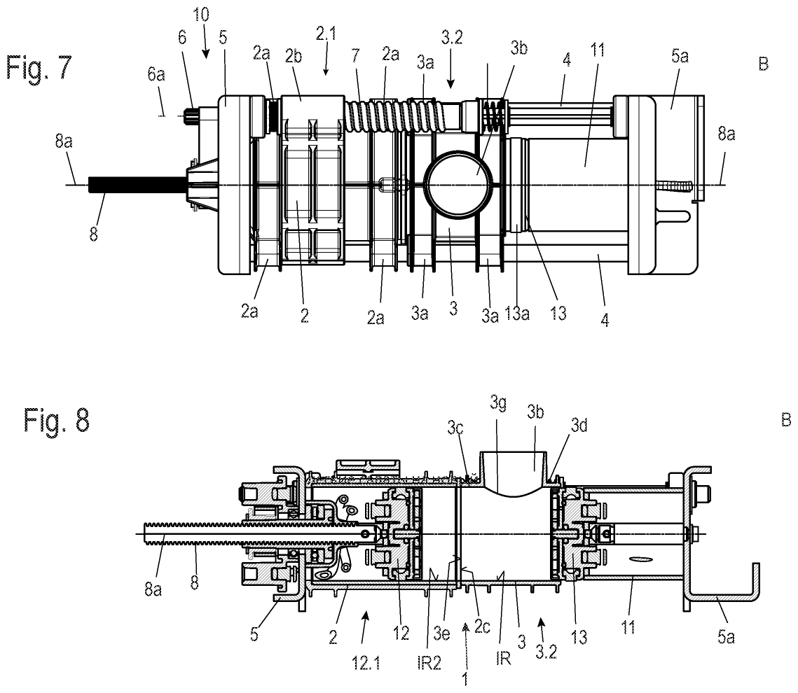

FIG. 6 shows a schematic perspective view of the first embodiment example according to FIG. 1 in the first filling position. FIG. 7 shows a schematic top view of the first embodiment example in the first filling position. FIG. 8 shows a longitudinal section of the brewing unit 1 in the first filling position.

In the first filling position of the brewing unit 1, the brewing slide 2 is in its first brewing slide position 2.1, whereby the shower screen 12 is also in its first shower screen position 12.1.

However, in this first filling position of the brewing unit 1, the filling tray 3 is moved between the brewing slide 2 and the plunger 13 into a second filling tray position 3.2. The interior IR of the filling tray 3 is now connected to the interior IR2 of the brewing slide 2, whereby the end face 3e of the filling tray 3 lies tightly against the end face 2c of the brewing slide 2. An undesignated seal is provided for this purpose. On the other side of the filling tray 3, the collar 3d of the filling tray 3 facing the plunger base plate 5a is closed by the plunger 13.

The filling tray 3 is moved to its second filling tray position 3.2 by the brewing slide 2 in the following manner.

The starting position is brewing unit position 1 (open position according to FIG. 1, 2, 4, 5).

The brewing slide 2 is first moved together with the shower screen 12 in it from the first brewing slide position 2.1 (shower screen 12 from the first shower screen position 12.1) in the direction of the filling tray 3 in its first filling tray position 3.1 (FIG. 1, 2, 4, 5) until the end face 2c of the brewing slide 2 rests against the end face 3e of the filling tray 3. The filling tray 3 is not displaced by the brewing slide 2 in its first filling tray position 3.1, as the filling tray 3 is fixed by the controllable seal 13a of the plunger 13.

There is also another situation in which the filling tray 3 rests directly against a plunger side 5b of the plunger base plate 5a with its end face 3f facing the plunger base plate 5a. In this case the filling tray 3 is in a third filling tray position 3.3, which is shown in FIGS. 9, 10, 11 in the brewing unit position C. In this case, the controllable seal 13a of the plunger 13 is not activated.

In both filling tray positions 3.1 and 3.3, the filling tray 3 is then coupled to the brewing slide 2 by means of the holding elements 14. The filling tray 3 coupled to the brewing slide 2 in this way is then pulled from its first filling tray position 3.1 or from its third filling tray position 3.3 down from the stationary storage sleeve 11 into the second filling tray position 3.2.

In this way, the first filling position of the brewing unit 1 is assumed in its brewing unit position B.

In the first filling position, ground coffee K can now be filled into the filling tray 3 directly into its interior IR through the filling neck 3b. This can be clearly seen in FIG. 15.

A second filling position can be formed in the brewing unit position A and offers a further possibility of initially filling coffee powder K into the filling neck 3b of the filling tray 3, which is in its first filling tray position 3.1. In this case, the outer wall of the storage sleeve 11 forms a closure of the opening 3g of the filling neck 3b, whereby the coffee powder K initially remains in the filling neck 3b. This is shown in FIG. 2.

Subsequently, when the brewing unit is in position B, the coffee powder K already in the filling neck 3b is drawn into the interior IR of the filling tray 3 through the now uncovered opening 3g by the backward movement of the brewing slide 2 together with the filling tray 3 in the direction of the drive base plate 5.

Other intermediate positions between the first filling tray position 3.1 and the second filling tray position 3.2 are conceivable in this way, in which coffee powder K can be filled into the filling neck 3b of the filling tray 3. This depends, for example, on the length of the storage sleeve 11. For example, the third filling tray position 3.3 in the brewing unit position C can enable a further second or third filling position.

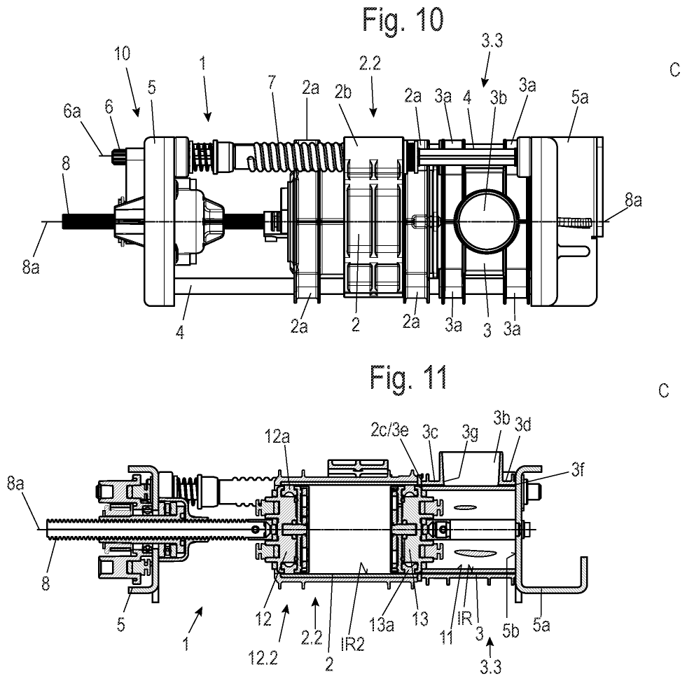

FIG. 9 shows a schematic perspective view of the first embodiment example according to FIG. 1 in an immersion position. FIG. 10 shows a schematic top view of the first embodiment example in the immersion position of the brewing unit 1. FIG. 12 shows a longitudinal section.

In the brewing unit position C, which here forms a so-called immersion position of the brewing unit 1, the brewing slide 2 is in a second brewing slide position 2.2.

Together with the brewing slide 2, the shower screen 12 is moved to a second shower screen position 12.2 and closes the brewing slide 2, i.e. its brewing chamber in its interior, on the side facing the drive base plate 5. The other side of the brewing slide 2 is located above the seal 13a of the plunger 13, which is thus “immersed” in the brewing slide 2.

In this way, the interior of the brewing slide 2, i.e. the brewing chamber, is closed by the shower screen 12 and the plunger 13, with the coffee powder (not shown here, but illustrated in FIG. 16) between the shower screen 12 and the plunger 13 in the interior of the brewing slide 2.

In this third filling position of the brewing unit 1, the filling tray 3 is moved by the brewing slide 2 between the latter and the plunger base plate 5a into the third filling tray position 3.3 already mentioned above and is pushed completely over the storage sleeve 11. The storage sleeve 11 is arranged in the interior IR of the filling tray 3.

The end face 3e of the filling tray 3 lies close to the end face 2c of the brewing slide 2. On the other side of the filling tray 3, the end face 3f of the collar 3d of the filling tray 3, which faces the plunger base plate 5a, rests against the plunger side 5b of the plunger base plate 5a as a stop. The third filling tray position 3.3 thus differs from the first filling tray position 3.1 (see FIGS. 1, 2, 4, 5).

The immersion position of the brewing unit 1 in its brewing unit position C is assumed in the following way.

The filling tray 3 is moved to its second filling tray position 3.2 by the brewing slide 2 from the first filling position in the brewing unit position B (see FIGS. 6, 7, 8) as the initial position.

The brewing slide 2 is moved together with the shower screen 12 located in it from the first brewing slide position 2.1 (shower screen 12 from the first shower screen position 12.1) together with the filling tray 3 until the end face 3f of the filling tray 3 facing the plunger base plate 5a comes into contact with the plunger side 5b of the plunger base plate 5a and the brewing slide 2 assumes its second brewing slide position 2.2.

In this case, an adjustment speed of the brewing slide 2 is greater than an adjustment speed of the shower screen 12. The difference in the adjustment speeds is such that the shower screen 12 closes the brewing chamber of the brewing slide 2 on the side of the brewing slide 2 facing the drive base plate 5 when the brewing unit is in its second shower screen position 12.2, as already described above.

Now the coffee powder Kᵢ in the brewing chamber inside the brewing slide 2 (see FIG. 16) is compacted by a further adjusting movement of the shower screen 12 from its second shower screen position 12 towards the plunger 13. During this process, the brewing slide 2 and the filling tray 3 remain in their positions 2.2 and 3.3 of the immersion position of the brewing unit 1 in the brewing unit position C. This achieves a so-called closed position of the brewing unit 1 in the brewing unit position D, which is described below.

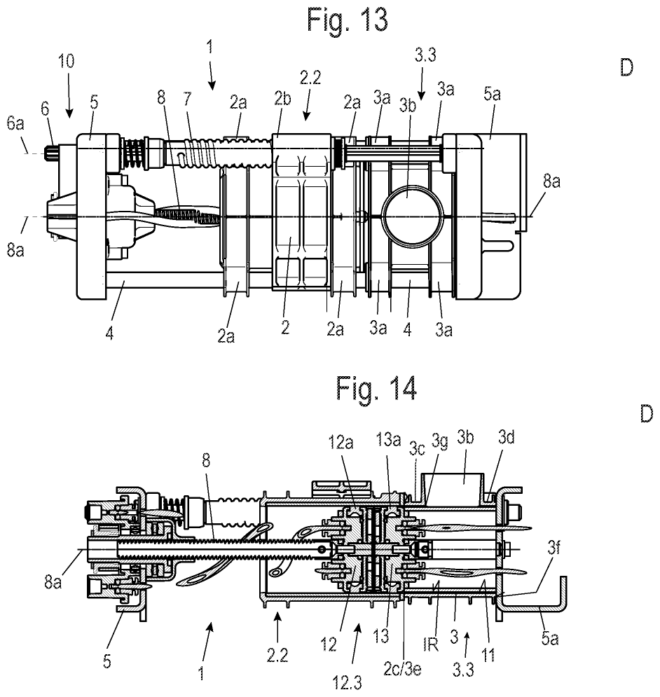

FIG. 12 shows a schematic perspective view of the first embodiment example according to FIG. 1 in the closed position of the brewing unit 1, which is designated as brewing unit position D. FIG. 13 shows a schematic top view of the first embodiment example in the brewing unit position D. FIG. 14 shows a longitudinal section of the brewing unit 1 in brewing unit position D.

As in the immersion position in brewing unit position C, in brewing unit position D the brewing slide 2 is in its second brewing slide position 2.2 and the filling tray 3 is in its third filling tray position 3.3. However, the shower screen 12 is inside the brewing slide 2 in a third shower screen position 12.3 close to the plunger 13. In this case, the coffee powder Kᵢ (see FIG. 15) located between shower screen 12 and plunger 13 is compressed for a subsequent brewing process.

In the brewing unit position D, the filling tray 3 is moved by the brewing slide 2 between the latter and the plunger base plate 5a into its third filling tray position 3.3 and is pushed completely over the storage sleeve 11. The storage sleeve 11 is arranged in the interior IR of the filling tray 3.

The end face 3e of the filling tray 3, which faces the drive base plate 5, lies close to the end face 2c of the brewing slide 2. On the other side of the filling tray 3, the collar 3d of the filling tray 3 facing the plunger base plate 5a rests with its end face 3f against the plunger side 5b of the plunger base plate 5a as a stop. In other words, the filling tray position 3.3 is an end position of the filling tray 3.

The end area of the brewing slide 2 with the end face 2c, which rests against the end face 3e of the filling tray 3, is arranged above the seal 13a of the plunger 13, which in this way is “immersed” in the brewing slide 2 and closes the inside of the brewing slide 2, i.e. the brewing chamber.

After a product-specific amount of water has flowed through, the moistened coffee powder is pressed out and the coffee cake (pomace) is discharged into a pomace container.

To do this, the brewing unit 1 is moved to its open position as the brewing unit position A from the closed brewing unit position D as follows.

The brewing slide 2 and the shower screen 12 move from the brewing unit position D in the direction of the drive base plate 5. The coupling of the filling tray 3 to the brewing slide 2 by means of the holding elements 14 is thereby cancelled.

In the case of electromagnetic holding elements 14, these are deactivated by switching off the current and the filling tray 3 remains in its third filling tray position 3.3 (end position).

If the holding elements 14 are formed as permanent magnets, the filling tray 3 is moved by the brewing slide 2 in the direction of the drive base plate 5 until the collar 3c facing the brewing slide 2 or the drive base plate 5 is positioned above the seal 13a of the plunger 13. Then the controllable seal 13a is applied, e.g. by hydraulic pressure, and fixes the filling tray 3 in its second filling tray position 3.2 (see FIGS. 1, 2, 4, 5). The holding force of the holding elements 14, which are formed as permanent magnets, is formed in such a way that a further movement of the brewing slide 2 in the direction of the drive base plate 5 cancels the coupling of the brewing slide 2 with the filling tray 3.

When the brewing slide 2 is moved further, the filling tray 3 remains in this way either in its third filling tray position 3.3 or in its second filling tray position 3.2. The distance between the opposite end faces 2c of the brewing slide 2 and 3e of the filling tray 3 is increased.

As the brewing slide 2 moves back faster than the shower screen 12, the coffee cake (marc) still inside the brewing slide 2 is ejected from the shower screen 12 into the ejection area 9 into a (not shown, but easily imaginable) collecting container.

The brewing unit position D is therefore also called the coffee ground ejection position.

The brewing slide 2 and the shower screen 12 are moved back to their first positions 2.1 and 12.1 in the brewing unit position A.

In the brewing unit position D, i.e. the coffee ground ejection position, it is also possible to grind through the brewing unit 1 into the collection container (pomace container) in the ejection area 9 in order to then be able to assess the ground coffee powder K in terms of fineness and grinding quantity.

In addition, it is possible to add larger quantities of coffee powder K in a continuous grinding process in the standard filling position, i.e. in the brewing unit position B. This is described below in connection with FIGS. 15 and 16. This is described below in connection with FIGS. 15 and 16.

FIG. 15 shows a schematic sectional view of the first embodiment according to FIG. 1 in the first filling position in the brewing unit position B. FIG. 16 shows the brewing unit in position C.

In the process, coffee is deliberately ground in through the filling neck 3b beyond what is actually a possible filling height limit 15 of the interior IR of the filling tray 3. The interior IR is thus completely filled with coffee powder Kᵢ, with the further excess coffee powder Kₐ accumulating in the filling neck 3b.

When the brewing unit is in position C, the filling tray 3 is pushed over the storage sleeve 11. The coffee powder Kᵢ which is now inside the brewing slide 2 between the shower screen 12 and the plunger 13 is pressed against the plunger 13 and compacted by the further movement of the shower screen 12 when the brewing unit position D is assumed.

The coffee powder Kₐ in the filling neck 3b is then drawn into the interior of the brewing slide 2 by additional back and forth/reciprocating movements of the brewing slide 2 and the shower screen 12 and compressed with the coffee powder Kᵢ present there. During these back and forth movements, the brewing unit 1 moves from the brewing unit position D via the brewing unit position C into the brewing unit position B. Since the coffee powder Kᵢ is now compacted in the brewing slide 2, there is space for the remaining coffee powder Ka from the filling neck 3b, which automatically enters the interior IR of the filling tray 3 by gravity when the brewing unit moves to brewing unit position B.

A number of these back and forth movements depends on the residual amount of coffee powder Kₐ remaining in the filling neck 3b of the filling tray 3 in each case. This described movement leads to an optimised distribution of the total amount of coffee powder Kₐ in the existing brewing space inside the brewing slide 2. Overall, the filling of the brewing unit 1 with larger weights can thus be implemented significantly faster than if the coffee powder K is ground in several partial steps. This process can also be referred to as indirect filling.

The higher the filling neck 3b of the filling tray 3, the greater the quantity of coffee powder K that can be fed to the brewing chamber inside the brewing slide 2 via the indirect filling described above. With a high filling spout 3b of the filling tray 3, such indirect filling is of course also possible from the second or further filling position.

If the filling neck 3b extends directly under the grinder outlet opening of a grinder that is not shown here but can easily be imagined, a conventional powder funnel for guiding the coffee powder K into the filling neck 3b in a targeted manner can even be omitted. This results in a further advantage.

Hot water vapour usually rises from the ejected coffee cake (pomace) into the powder funnel and condenses there. As a result, coffee powder that is subsequently filled in can more easily stick to the wall of the powder funnel, so that there is a risk of the powder funnel gradually becoming completely clogged. The fact that the powder funnel is part of the filling neck 3b of the filling tray 3 as described above and that this is moved out of the filling area, i.e. out of the ejection area 9, in the coffee ground ejection position (brewing unit position D) prevents excessive moistening of the powder funnel or the filling neck 3b.

Finally, the option of more than one filling position allows a particularly clever positioning of more than two grinders in a coffee machine that feed into the same brewing unit 1. Consequently, for example, two identical bean containers can be arranged next to and behind each other at the same time and yet the ejection snouts of the grinders can be made very short. This allows for the smallest possible amount of coffee powder residue from old grindings and a visually very appealing machine design.

The second or/and further filling position of the brewing unit 1, e.g. when the filling tray 3 is in its second filling tray position 3.2 or third filling tray position 3.3, makes it possible to place cleaning agent, in particular cleaning tablets, in the filling neck 3b of the filling tray 3. This cleaning agent is then held in the filling neck 3b by closing the opening 3g of the filling neck 3b by the storage sleeve 11 until it is drawn into the brewing space inside the brewing slide 2 (as described above) at a time defined by machine software of a control system of the brewing unit 1 and then dissolved accordingly by hot water.

Of course, it is also possible as an alternative to add the cleaning agent directly to the filling tray 3 instead of coffee powder K in the first filling position.

The filling of a horizontal brewing unit 1 of a coffee piston machine takes place in a first filling position or/and in at least one second filling position of the brewing unit 1.

FIGS. 17-18 show schematic views of a second embodiment of the brewing unit 1 according to the invention in an open position. FIG. 17 shows a schematic perspective view. FIG. 18 shows a longitudinal sectional view of the second embodiment of FIG. 17.

The brewing unit 1 of the second embodiment example comprises brewing unit positions A, B, C, D like that of the first embodiment example.

The brewing unit 1 of this second embodiment differs from that of the first embodiment as follows.

The brewing slide 2 and the filling tray 3 are made in one piece. This means that no holding elements 14 are provided.

The filling tray 3 completely encloses the brewing slide 2. The filling tray 3 forms a housing, e.g. as an injection moulded part, around the brewing slide 2, which can be e.g. a tubular metal inlay. An opening 2d to the interior IR2 of the brewing slide 2 is moulded into the wall of the brewing slide 2 below the opening 3g of the filling neck 3b.

In contrast to the first embodiment, the filling neck 3b of the filling tray 3 is located on the side of the filling tray 3 facing the drive base plate 5.

The guide sections 2a, 3a and also the drive section 2b of the combination of brewing slide 2 and filling tray 3 are components of the filling tray 3 here, but they can also be separate parts or parts of the brewing slide 2. The end faces 3e and 3f of the filling tray 3 are offset slightly inwards from the end faces of the brewing slide 2.

The shower screen 12 is connected to the storage sleeve 11 and can be adjusted to various positions together with the latter. The storage sleeve 11 is a circular cylindrical tube with a base 11e. The base 11e is firmly connected to the side of the shower screen 12 facing the drive base plate 5 via the end face 10a. The other end 11b faces the drive base plate 5 and forms an opening to an interior 11d of the storage sleeve 11.

The plunger 13 is directly attached to the plunger side 5b of the plunger base plate 5a.

Furthermore, a bearing unit 16 for the inner spindle 8 is attached to the inside of the drive base plate 5. The bearing unit 16 extends in the direction of the plunger base plate 5a over about one fifth of the distance between the drive base plate 5 and the plunger base plate 5a.

The brewing slide 2, which is formed integrally with the filling tray 3, and the shower screen 12, which is connected to the storage sleeve 11, are independently and dependently adjustable into different positions to form the brewing unit positions A, B, C, D of the brewing unit.

These different positions of brewing slide 2/filling tray 3 and storage sleeve 11/shower screen 12 differ from those of the first embodiment. Thus, the common positions of brewing slide 2/filling tray 3 are indicated by the reference signs 2-A, 2-B; 3-A, 3-B, and the common positions of storage sleeve 11/shower screen 12 are indicated by 11-A, 11-B, 11-C, 11-D; 12-A, 12-B, 12-C, 12-D.

In the brewing unit position A, the brewing slide 2, which is formed integrally with the filling tray 3, is in a brewing slide/filling tray position 2-A; 3-A, which is referred to as the starting position. In this case, the brewing slide 2 surrounds an end area 16a of the outer surface of a housing of the bearing unit 16 with a collar section 2e, which is surrounded by the collar 3c of the filling tray 3 facing the drive base plate 5.

The shower screen 12 is completely accommodated with the storage sleeve 11 inside the interior IR2 of the brewing slide 2. The end face of the shower screen 12 facing the plunger base plate 5a is aligned with the end face 2c of the brewing slide 2 facing the plunger base plate.

The shower screen 12 is thus also in an initial position, which is called here the storage sleeve/shower screen position 11-A, 12-A.

In this brewing unit position A, the ejection area 9 is defined between the shower screen 12 and the plunger 13.

The brewing unit position A can also be used as another filling position.

A first filling position, also called conventional filling position or conventional filling position, is assumed in the brewing unit position B.

FIG. 19 shows a schematic view of the second embodiment according to FIGS. 17-18 in the first filling position. FIG. 20 shows a longitudinal section.

In the first filling position of the brewing unit 1, the brewing slide 2 with the filling tray 3 is in a second brewing slide/filling tray position 2-B; 3B on the plunger base plate 5a. The shower screen 12 and the storage sleeve 11 are thereby moved into a second storage sleeve/shower screen position 11-B; 12-B in the direction of the drive base plate 5 from their first position 11-A; 12-A opposite to the direction of movement of the brewing slide 2 and filling tray 3.

In this position 2-B; 3B, the end section of the brewing slide 2 facing the plunger base plate 5a is arranged above the plunger 13, with the end face 2c resting against the plunger side 5b of the plunger base plate 5a or being a short distance in front of it. The plunger 13 closes the interior IR2 of the brewing slide 2 from the side of the plunger base plate 5a.

On the opposite side, the internal space IR2 of the brewing slide 2 is closed by the shower screen 12, now in its second position 12-B, and its seal 12a in cooperation with the end portion 2e.

The storage sleeve 11 is inserted under the end area of the housing shell of the bearing unit 16 with its end section 11c facing the drive base plate 5 and its end face 11b.

By moving the shower screen 12 (with the storage sleeve 11) into its second position 12-B, the interior IR2 of the brewing slide 2 is now accessible through the two openings 2d and 3g for the coffee powder K located in the filling neck 3b. Thus, in this first filling position, coffee powder K can be fed directly through the filling neck into the interior IR2 of the brewing slide 2. The coffee powder K can also be ground into the filling neck 3b beforehand in the second filling position (brewing unit position A) and stored in it.

FIG. 21 shows a schematic view of the second embodiment according to FIGS. 17-18 in an immersion position. FIG. 22 shows a longitudinal sectional view of this.

The immersion position is formed in the brewing unit position C. Here, the brewing slide 2 with the filling tray 3 is still in the second brewing slide/filling tray position 2-B; 3B on the plunger base plate 5a.

The coffee powder Kᵢ located in the interior IR2 of the brewing slide 2 is pressed together against the plunger 13 by the immersing shower screen 12, in that the storage sleeve 11 with the shower screen 12 is now moved in the direction of the plunger base plate 5a to a further position 11-C; 12-C. In doing so, both the shower screen 12 and the storage sleeve 11 attached to it close the opening 2d of the brewing slide 2 to the opening 3g of the filling spout 3b of the filling tray 3.

In contrast to the first embodiment, the coffee powder Kₐ in the filling neck 3b is then drawn into the brewing chamber into the interior IR2 of the brewing slide 2 by additional back and forth movements of the storage sleeve 11 and the shower screen 12 and compressed with the coffee powder Kᵢ present there. During these back and forth movements, the brewing unit 1 moves from brewing unit position B to brewing unit position C.

In the first filling position of the brewing unit 1 (see FIGS. 15, 20), it is also possible for a permanent grinding process to take place, in which coffee powder is constantly ground into the filling neck 3b and thus either directly into the interior IR of the filling tray 3 (in the first embodiment example, e.g. in FIG. 15) or directly into the interior IR2 (brewing chamber) of the brewing slide 2 (in the second embodiment example, e.g. in FIG. 20).

During such a permanent grinding process, the brewing slide 2 and the filling tray 3 are moved back and forth so quickly that the coffee powder is distributed in the interior IR of the filling tray 3 or in the interior IR2 of the brewing slide 2 during the grinding process in such a way that more than the usual 13 to 15 g of coffee powder can be ground in one continuous grinding process. A stroke of this rapid back and forth movement is only so great that the side of the respective interior IR of the filling tray 3 or IR2 of the brewing slide 2 facing the plunger base plate 5a remains closed by the plunger 13. I.e. the stroke of the back and forth movement here comprises a maximum length that is smaller than the length of the plunger 13 in the direction of the inner spindle axis 8a. This rapid back and forth movement of the brewing slide 2 with filling tray 3 is also referred to as “shaking”.

The term “permanent grinding process” means that the grinding process during the filling of coffee powder K into the respective interior IR, IR2 is only interrupted when a predetermined amount of coffee powder K is present in the respective interior IR, IR2. This can be done, for example, by detecting the position of the shower screen 12, e.g. by means of an angle detection of the associated positioning drive.

FIG. 23 shows a schematic view of the second embodiment according to FIGS. 17-18 in a closed position in the brewing unit position D.

In this brewing unit position D, storage sleeve 11 and shower screen 12 continue to move towards the plunger base plate 5a to position 11-D; 12-D. This is not shown here, but is easy to understand in connection with FIG. 14 and the associated description.

FIG. 24 shows a schematic flow diagram of an embodiment example of the process according to the invention for filling the horizontal brewing unit 1 of the coffee piston machine both in the first filling position and in at least one second filling position.

In a first process step VS1, the brewing unit 1 is moved to the brewing unit position B, which is the first filling position.

In a second process step VS2, coffee powder K is ground or filled through the filling spout 3b of the filling tray 3 into the interior IR of the filling tray 3 or into the interior IR2 of the brewing slide 2 if the brewing slide 2 and the filling tray 3 are of one-piece design and the brewing slide 2 is arranged inside the filling tray 3.

In a third process step VS3, further coffee powder K is ground or filled into the interior IR of the filling tray 3 or into the interior IR2 of the brewing slide 2 if the brewing slide 2 and the filling tray 3 are constructed in one piece and the brewing slide 2 is arranged inside the filling tray 3. the filling height limit 15 of the interior IR of the filling tray 3 or of the interior IR2 of the brewing slide 2 is exceeded, the interior IR of the filling tray 3 or the interior IR2 of the brewing slide 2 is thereby completely filled with coffee powder Kᵢ and the further excess coffee powder Kₐ accumulates in the filling neck 3b.

Then, in a fourth process step VS4, by at least one reciprocating movement of the brewing slide 2, the shower screen 12 and the filling tray 3 or only the shower screen 12 connected to the storage sleeve 11, if the brewing slide 2 and the filling tray 3 are formed in one piece and the brewing slide 2 is arranged inside the filling tray 3, the coffee powder Kₐ stored in the filling neck 3b of the filling tray 3 is drawn into the interior IR2 of the brewing slide 2 and is further compressed with the coffee powder Kᵢ present there, wherein the brewing unit 1 executes the at least one reciprocating movement from the brewing unit position B via the brewing unit position C into the brewing unit position D or from the second brewing unit position B into the third brewing unit position C, if the brewing slide 2 and the filling tray 3 are formed in one piece and the brewing slide 2 is arranged within the filling tray 3, and back again at least once.

In one embodiment, a permanent grinding process takes place in the process steps VS2, VS3 Grinding and filling coffee powder K, respectively, wherein the brewing slide 2 and the filling tray 3 are moved back and forth rapidly and the coffee powder is distributed in the interior IR of the filling tray 3 or in the interior IR2 of the brewing slide 2 during the grinding process.

In a variant of the process, in the first process step VS′1 the brewing unit 1 is moved to the brewing unit position A, C or D, which in each case forms a second filling position.

In a second process step VS′2 of the process variant, coffee powder K is ground or filled into the filling neck 3b of the filling tray 3 and stored. The brewing unit 1 is then moved to the brewing unit position B, whereby the coffee powder K stored in the filling neck 3b enters the interior IR of the filling tray 3 or the interior IR2 of the brewing slide 2 if the brewing slide 2 and the filling tray 3 are formed as one piece and the brewing slide 2 is arranged inside the filling tray 3.

In a third process step VS′3, excess coffee powder Kₐ is left in the filling neck 3b of the filling tray 3 if, during filling of the interior IR of the filling tray 3 or of the interior IR2 of the brewing slide 2, the brewing slide 2 and the filling tray 3 are formed in one piece and the brewing slide 2 is arranged inside the filling tray 3, a filling height limit 15 of the interior IR of the filling tray 3 or of the interior IR2 of the brewing slide 2, if the brewing slide 2 and the filling tray 3 are formed in one piece and the brewing slide 2 is arranged inside the filling tray 3, is exceeded with the coffee powder K stored in the filling spout 3b of the filling tray 3.

Then, in a fourth process step VS′4 of the process variant, by at least one back and forth movement of the brewing slide 2, the shower screen 12 and the filling tray 3 or a shower screen 12 connected to a storage sleeve 11, if the brewing slide 2 and the filling tray 3 are formed in one piece and the brewing slide 2 is arranged inside the filling tray 3, the coffee powder Kₐ stored in the filling sleeve 3b of the filling tray 3 is drawn into the brewing chamber into the interior IR2 of the brewing slide 2 and is further compressed with the coffee powder Kᵢ present there, wherein the brewing unit 1 executes the at least one reciprocating movement from the brewing unit position B via the brewing unit position C into the brewing unit position D or from the second brewing unit position B into the third brewing unit position C, if the brewing slide 2 and the filling tray 3 are formed in one piece and the brewing slide 2 is arranged within the filling tray 3, and back again at least once.

Before the first process step VS1, VS′1 or/and after a brewing process according to the fourth process step VS4, VS′4, a cleaning process is carried out by filling cleaning agents, in particular cleaning tablets, into the filling neck 3b of the filling tray 3 in the second or further filling position of the brewing unit 1 in the brewing unit position A or D. The cleaning agents or cleaning tablets are then kept in the filling neck 3b by closing the opening 3g of the filling neck 3b by the storage sleeve 11 until a cleaning process is initiated by a machine. Then the cleaning agents or cleaning tablets are held in the filling neck 3b by closing the opening 3g of the filling neck 3b by the storage sleeve 11 until it is drawn into the brewing space in the interior IR2 of the brewing slide 2 in the brewing unit position B at a time defined by machine software of a control system of the brewing unit 1 and then dissolved by hot water.

Before the first process step VS1, VS′1 or/and after a brewing process according to the fourth process step VS4, VS′4, a distance is formed in the brewing unit position A between the brewing slide 2 and the filling tray 3 or between the brewing slide 2 connected to the filling tray 3 and a plunger 13, if the brewing slide 2 and the filling tray 3 are formed in one piece and the brewing slide 2 is arranged inside the filling tray 3, a distance is formed which defines an ejection area 9, and coffee powder K is ground into a collecting container (pomace container) in the ejection area 9 through the brewing unit 1 in order to then be able to assess the ground coffee powder K in terms of fineness and grinding quantity.

The invention is not limited by the embodiments given above, but can be modified within the scope of the claims.

Instead of the two base plates 5, 5a, a frame can also be used, for example.

### REFERENCE SIGNS

1 Brewing unit
2 Brewing slide
2a Guide section
2b Drive section
2c End face
2d Opening
2e Collar section
2.1; 2.2; 2-A; 2-B Brewing slide position
3 Filling tray
3a Guide section
3b Filling neck
3c, 3d Collar
3e, 3f End face
3g Opening
3.1; 3.2; 3.3; 3-A; 3-B Filling tray position
4 Tie rod
5 Drive base plate
5a Plunger base plate
5b Plunger side
6 Outer spindle
6a Outside spindle axis
7 Movement thread
8 Inner spindle
8a Internal spindle axis
9 Ejection area
10 Drive side
11 Storage sleeve
11a, 11b End face
11c End section
11d Cavity
11e Base
11-A; 11-B; 11-C; 11-D Storage sleeve position
12 shower screen
12a Seal
12.1; 12.2; 12.3; shower screen position
12-A; 12-B; 12-C; 12-D
13 Plunger
13a Seal
13b Plunger holder
13c Plunger head
14 Holding element
15 Filling height limit
16 Bearing unit
16a End area
A, B, C, D Brewing unit position
IR, IR2 Interior
K, Kₐ, Kᵢ Coffee powder
VS1, VS2, VS3, VS4 Procedure step

1: A brewing unit (1) of a piston coffee machine, the brewing unit (1) being formed with a brewing slide (2) as brewing chamber, a filling tray (3), a machine frame with two base plates (5, 5a), two piston units as a shower screen (12) and a plunger (13), and at least one drive motor,
wherein the brewing unit (1) is adjustable in four brewing unit positions comprising a first brewing unit position (A), a second brewing unit position (B), a third brewing unit position (C) and a fourth brewing unit position (D),
wherein the second brewing unit position (B) forms a first filling position of the brewing unit (1) for the supply of coffee powder (K) or cleaning agents,
wherein the brewing unit (1) comprises at least one second filling position for the supply of coffee powder or cleaning agents in the first, third and/or fourth brewing unit position (A, C, D),
wherein the brewing slide (2) and the filling tray (3) form separate assemblies and are configured to be coupled to one another via at least one holding element (14), wherein the brewing slide (2) is a driven component and the filling tray (3) is a component indirectly pushed or pulled by the drive motor via the brewing slide (2),
wherein the filling tray (3) comprises an outwardly facing filling neck (3b) which is connected to an interior (IR) of the filling tray (3) via an opening (3g),
wherein, in the at least one second filling position of the brewing unit (1) in a first filling tray position (3.1) in the first brewing unit position (A), and in a third filling tray position (3.3) in the third and fourth brewing unit positions (C, D), the filling tray (3) is pushed onto a storage sleeve (11), which is then arranged in the interior (IR) of the filling tray (3) and closes the opening (3g) of the filling neck (3b) of the filling tray (3).

2: The brewing unit (1) according to claim 1, wherein the at least one holding element (14) is a permanent magnet, electromagnet or/and a controllable mechanical coupling.

3: The brewing unit (1) according to claim 1, wherein the filling tray (3) is fixable in the at least one second filling position of the brewing unit (1) in the first filling tray position (3.1) in the first brewing unit position (A) and in the third filling tray position (3.3) in the third and fourth brewing unit positions (C, D) by means of at least one electromagnet or a controllable hydraulic seal.

4: The brewing unit (1) according to claim 1, wherein the storage sleeve (11) is a hollow cylinder with a circular cross-section and is arranged between a plunger head (13c) of the plunger (13) and a plunger base plate (5a).

5: The brewing unit (1) according to claim 1, wherein, in the first filling position of the brewing unit (1), the filling tray (3) is in the third brewing unit position (C) in a second filling tray position (3.2), in which the opening (3g) of the filling neck (3b) of the filling tray (3) is open and is connected to the interior (IR) of the filling tray (3).

6: The brewing unit (1) according to claim 1, wherein in the first brewing unit position (A) a distance is formed between the brewing slide (2) and the filling tray (3), which determines an ejection area (9).

7: A brewing unit (1) of a piston coffee machine, the brewing unit (1) being formed with a brewing slide (2) as brewing chamber, a filling tray (3), a machine frame with two base plates (5, 5a), two piston units as shower screen (12) and plunger (13), and at least one drive motor,
wherein the brewing unit (1) is adjustable in four brewing unit positions comprising a first brewing unit position (A), a second brewing unit position (B), a third brewing unit position (C) and a fourth brewing unit position (D),
wherein the second brewing unit position (B) forms a first filling position of the brewing unit (1) for the supply of coffee powder (K) or cleaning agents,
wherein the brewing unit (1) has at least one second filling position for the supply of coffee powder or cleaning agents in the first, third and/or fourth brewing unit position (A, C, D), and
wherein the brewing slide (2) is firmly connected to the filling tray (3) and/or is formed in one piece with the filling tray.

8: The brewing unit (1) according to claim 7, wherein the brewing slide (2) is formed integrally with the filling tray (3) in such a way that the brewing slide (2) is arranged in an interior (IR) of the filling tray (3).

9: The brewing unit (1) according to claim 8, wherein the filling tray (3) comprises an outwardly pointing filling neck (3b) which is connected to an interior (IR2) of the brewing slide (2) via an opening (3g) and a further opening (2d) of the brewing slide (2).

10: The brewing unit (1) according to claim 7, wherein the shower screen (12) is connected to a storage sleeve (11), wherein the storage sleeve (11) is inserted with the connected shower screen (12) into the interior (IR2) of the brewing slide (2), which is formed integrally with the filling tray (3), in the at least one second filling position of the brewing unit (1) in the first brewing unit position (A) and in the third and fourth brewing unit positions (C, D), which then closes the opening (2d) of the brewing slide (2) and the opening (3g) of the filling neck (3b) of the filling tray (3).

11: The brewing unit (1) according to claim 1, wherein in the first brewing unit position (A) a distance is formed between the brewing slide (2), which is fixedly connected to the filling tray (3), and the plunger (13), which distance defines an ejection area (9).

12: The brewing unit (1) according to claim 1, wherein the brewing unit (1) is formed as a spindle brewing unit.

13: A piston coffee machine with a brewing unit (1) according to claim 1.

14: A process for filling a horizontal brewing unit (1) according to claim 1 of a coffee piston machine, wherein the filling of the brewing unit (1) takes place in the first filling position of the brewing unit (1) or/and in the at least one second filling position of the brewing unit (1),
wherein the filling of the brewing unit (1) in the first filling position of the brewing unit (1) comprises the following process steps:
(VS1) Moving the brewing unit (1) into the second brewing unit position (B), which forms the first filling position;
(VS2) Grinding or filling coffee powder (K) through the filling neck (3b) of the filling tray (3) into an interior (IR) of the filling tray (3);
(VS3) Grinding or filling further coffee powder (K) through the filling neck (3b) of the filling tray (3) into the interior (IR) of the filling tray (3), wherein a filling height limit (15) of the interior (IR) of the filling tray (3) or of the interior (IR2) of the brewing slide (2) is exceeded, the interior (IR) of the filling tray (3) or the interior (IR2) of the brewing slide (2) is thereby completely filled with coffee powder (Kᵢ) and excess coffee powder (Kₐ) accumulates in the filling neck (3b) of the filling tray (3); and
(VS4) Performing at least one back and forth movement of the brewing slide (2), a shower screen (12) and the filling tray (3), and drawing the coffee powder (Kₐ) stored in the filling neck (3b) of the filling tray (3) into the brewing chamber into the interior (IR2) of the brewing slide (2) and compressing the stored coffee powder (Kₐ) with the coffee powder (Kᵢ) present in the interior (IR2) of the brewing slide (2), wherein the brewing unit (1) performs the at least one back and forth movement from the second brewing unit position (B) via the third brewing unit position (C) into the fourth brewing unit position (D) or from the second brewing unit position (B) into the third brewing unit position (C) if the brewing slide (2) and the filling tray (3) are formed in one piece and the brewing slide (2) is arranged within the filling tray (3), and back again at least once.

15: The process according to claim 14, wherein in the process steps (VS2, VS3) of grinding in or filling in coffee powder (K), a permanent grinding process takes place, wherein the brewing slide (2) and the filling tray (3) are moved back and forth rapidly and wherein the coffee powder (K) is distributed in the interior (IR) of the filling tray (3) or in the interior (IR2) of the brewing slide (2) during the grinding process.

16: The process according to claim 14, wherein the filling of the brewing unit (1) in the at least one second filling position of the brewing unit (1) comprises the process steps
(VS′1) Moving the brewing unit (1) into the first, third or fourth brewing unit position (A, C or D), which in each case forms a second filling position;
(VS′2) Grinding or filling in coffee powder (K) filling coffee powder (K) into a filling neck (3b) of the filling tray (3) and storing the coffee powder (K) in the filling neck (3b) of the filling tray (3) and moving the brewing unit (1) into the second brewing unit position (B), wherein the coffee powder (K) stored in the filling neck (3b) of the filling tray (3) passes into an interior space (IR) of the filling tray (3);
(VS′3) Remaining of excess coffee powder (Kₐ) in the filling neck (3b) of the filling tray (3) when filling the interior (IR) of the filling tray (3) with the coffee powder (K) stored in the filling neck (3b) of the filling tray (3), a filling height limit (15) of the interior (IR) of the filling tray (3) or of the interior (IR2) of the brewing slide (2), if the brewing slide (2) and the filling tray (3) are formed in one piece and the brewing slide (2) is arranged inside the filling tray (3), is exceeded; and
(VS′4) Performing at least one back and forth movement of the brewing slide (2), a shower screen (12) and the filling tray (3) and drawing the coffee powder (Kₐ) stored in the filling neck (3b) of the filling tray (3) into the brewing space in the interior (IR2) of the brewing slide (2) and compressing the stored coffee powder (Kₐ) with the coffee powder (Kᵢ) present in the interior of the brewing slide (2), wherein the brewing unit (1) performs the at least one back and forth movement from the second brewing unit position (B) via the third brewing unit position (C) into the fourth brewing unit position (D) or from the second brewing unit position (B) into the third brewing unit position (C) if the brewing slide (2) and the filling tray (3) are formed in one piece and the brewing slide (2) is arranged inside the filling tray (3), and back again at least once.

17: The process according to claim 14, wherein before the first process step (VS1, VS′1) or/and after a brewing process according to the fourth process step (VS4, VS′4) a cleaning process is carried out by filling cleaning agents, in particular cleaning tablets, into the filling neck (3b) of the filling tray (3) in the at least one second filling position of the brewing unit (1) in the first or fourth brewing unit position (A or D), wherein thereafter the cleaning agents or cleaning tablets are held in the filling neck (3b) by closing the opening (3g) of the filling neck (3b) by the storage sleeve (11) until the cleaning agents or cleaning tablets are drawn into the brewing space in the interior (IR2) of the brewing slide (2) in the second brewing unit position (B) at a time defined by machine software of a control of the brewing unit (1) and then dissolved by hot water.

18: The process according to claim 14, wherein before the first process step (VS1, VS′1) or/and after a brewing operation after the fourth process step (VS4, VS′4), a distance is formed in the first brewing unit position (A) between the brewing slide (2) and the filling tray (3), a distance is formed which defines an ejection area (9).

19: A process for filling a horizontal brewing unit (1) according to claim 7 of a coffee piston machine, wherein the filling of the brewing unit (1) takes place in the first filling position of the brewing unit (1) or/and in the at least one second filling position of the brewing unit (1), wherein the brewing slide (2) and the filling tray (3) are formed in one piece and the brewing slide (2) is arranged inside the filling tray (3), wherein the filling of the brewing unit (1) in the first filling position of the brewing unit (1) comprises the following process steps:
(VS1) Moving the brewing unit (1) into the second brewing unit position (B), which forms the first filling position;
(VS2) Grinding or filling coffee powder (K) into an interior (IR2) of a brewing slide (2);
(VS3) Grinding or filling further coffee powder (K) into the interior (IR2) of the brewing slide (2), wherein a filling height limit (15) of the interior (IR) of the filling tray (3) or of the interior (IR2) of the brewing slide (2) is exceeded, the interior (IR) of the filling tray (3) or the interior (IR2) of the brewing slide (2) is thereby completely filled with coffee powder (Kᵢ) and excess coffee powder (Kₐ) accumulates in the filling neck (3b) of the filling tray (3); and
(VS4) Performing at least one back and forth movement of the brewing slide (2), a shower screen (12) connected to a storage sleeve (11), and drawing the coffee powder (Kₐ) stored in a filling neck (3b) of the filling tray (3) into the brewing chamber into the interior (IR2) of the brewing slide (2) and compressing the stored coffee powder (Kₐ) with the coffee powder (Kᵢ) present in the interior (IR2) of the brewing slide (2), wherein the brewing unit (1) performs the at least one back and forth movement from the second brewing unit position (B) into the third brewing unit position (C) and back again at least once.

20: The process according to claim 19, wherein the filling of the brewing unit (1) in the at least one second filling position of the brewing unit (1) comprises the process steps:
(VS′1) Moving the brewing unit (1) into the first, third or fourth brewing unit position (A, C or D), which in each case forms a second filling position;
(VS′2) Grinding or filling in coffee powder (K) into a filling neck (3b) of the filling tray (3) and storing the coffee powder (K) in the filling neck (3b) of the filling tray (3) and moving the brewing unit (1) into the second brewing unit position (B), wherein the coffee powder (K) stored in the filling neck (3b) of the filling tray (3) passes into an interior space (IR2) of the brewing slide (2);
(VS′3) Remaining of excess coffee powder (Kₐ) in the filling neck (3b) of the filling tray (3) when filling the interior (IR2) of the brewing slide (2), with the coffee powder (K) stored in the filling neck (3b) of the filling tray (3), a filling height limit (15) of the interior (IR) of the filling tray (3) or of the interior (IR2) of the brewing slide (2), if the brewing slide (2) and the filling tray (3) are formed in one piece and the brewing slide (2) is arranged inside the filling tray (3), is exceeded; and
(VS′4) Performing at least one back and forth movement of a shower screen (12) connected to a storage sleeve (11), and drawing the coffee powder (Kₐ) stored in the filling neck (3b) of the filling tray (3) into the brewing space in the interior (IR2) of the brewing slide (2) and compressing the stored coffee powder (Kₐ) with the coffee powder (Kᵢ) present in the interior of the brewing slide (2), wherein the brewing unit (1) performs the at least one back and forth from the second brewing unit position (B) into the third brewing unit position (C), and back again at least once.
